(19) United States
(12) Patent Application Publication
(10) Pub. No.: US 2015/0026614 A1
(43) Pub. Date: Jan. 22, 2015

(54) INFORMATION PROCESSOR, NON-TRANSITORY COMPUTER READABLE MEDIUM, AND INFORMATION PROCESSING METHOD

(71) Applicant: FUJI XEROX CO., LTD., Tokyo (JP)

(72) Inventor: Makoto Yoshimi, Kanagawa (JP)

(73) Assignee: FUJI XEROX CO., LTD., Tokyo (JP)

(21) Appl. No.: 14/230,249

(22) Filed: Mar. 31, 2014

(30) Foreign Application Priority Data
Jul. 18, 2013 (JP) 2013-149617

(51) Int. Cl. G06F 3/0484; G06F 3/0482; G06F 3/0481

(52) U.S. Cl. CPC G06F 3/04845; G06F 3/04817; G06F 3/0482
USPC 715/765

(57) ABSTRACT

An information processor includes a display controller. The display controller controls display of a plurality of items displayed in alignment on a display on the basis of operation contents performed on an operation unit disposed to be superimposed on the display. If a first operation involving contact with the operation unit is performed on one item and another item of the plurality of items, the display controller controls the display to bring a plurality of aligned items from the one item to the another item into a selected state.

### CROSS-REFERENCE TO RELATED APPLICATIONS

This application is based on and claims priority under 35 USC 119 from Japanese Patent Application No. 2013-149617 filed Jul. 18, 2013.

### BACKGROUND

### Technical Field

The present invention relates to an information processor, a non-transitory computer readable medium, and an information processing method.

### SUMMARY

According to an aspect of the invention, there is provided an information processor including a display controller. The display controller controls display of plural items displayed in alignment on a display on the basis of operation contents performed on an operation unit disposed to be superimposed on the display. If a first operation involving contact with the operation unit is performed on one item and another item of the plural items, the display controller controls the display to bring plural aligned items from the one item to the another item into a selected state.

### BRIEF DESCRIPTION OF THE DRAWINGS

An exemplary embodiment of the present invention will be described in detail based on the following figures, wherein:

FIG. 1 is a block diagram illustrating an example of the configuration of an information processor according to an exemplary embodiment;

FIG. 2A is a schematic view illustrating an example of the configuration of a display screen when file information is displayed on a display by a display controller;

FIG. 2B is a schematic view for illustrating an item selecting operation of the information processor;

FIG. 2C is a schematic view for illustrating the item selecting operation of the information processor;

FIG. 2D consists of parts (a) and (b) as schematic views for illustrating the item selecting operation of the information processor;

FIG. 3 is a schematic view for illustrating a selected item editing operation of the information processor;

FIG. 4 is a schematic view for illustrating another example of the selected item editing operation of the information processor;

FIG. 5A is a schematic view for illustrating a selection cancelling operation of the information processor;

FIG. 5B is a schematic view for illustrating the selection cancelling operation of the information processor;

FIG. 6A is a schematic view for illustrating another example of the selection cancelling operation of the information processor;

FIG. 6B is a schematic view for illustrating the another example of the selection cancelling operation of the information processor;

FIG. 6C is a schematic view for illustrating the another example of the selection cancelling operation of the information processor;

FIG. 6D is a schematic view for illustrating the another example of the selection cancelling operation of the information processor;

FIG. 7A is a schematic view for illustrating another example of the selection cancelling operation of the information processor;

FIG. 7B is a schematic view for illustrating the another example of the selection cancelling operation of the information processor;

FIG. 7C is a schematic view for illustrating the another example of the selection cancelling operation of the information processor;

FIG. 7D is a schematic view for illustrating the another example of the selection cancelling operation of the information processor; and

FIG. 8 is a flowchart illustrating an operation example of the information processor.

### DETAILED DESCRIPTION

### Exemplary Embodiment

### Configuration of Information Processor

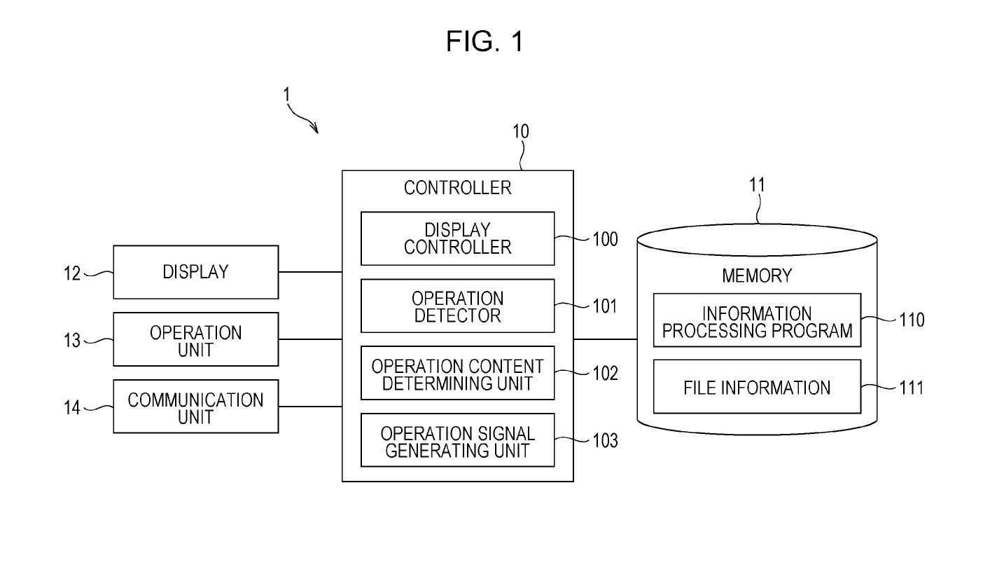

FIG. 1 is a block diagram illustrating an example of the configuration of an information processor according to an exemplary embodiment.

The information processor 1 includes a controller 10, a memory 11, a display 12, an operation unit 13, and a communication unit 14. The controller 10 configured by a central processing unit (CPU) and so forth controls the respective units and executes various programs. The memory 11 configured by a recording medium, such as a flash memory, stores information. The display 12 displays characters, images, and so forth. The operation unit 13 is a transparent touch pad superimposed on the display 12 to operate the information processor 1. The communication unit 14 communicates with an external device via a network.

The controller 10 executes a later-described information processing program 110 to function as a display controller 100, an operation detector 101, an operation content determining unit 102, and an operation signal generating unit 103, for example.

The display controller 100 displays file information 111 in a list. In the present exemplary embodiment, one piece of the file information 111 corresponds to one horizontally long rectangular item, and displaying plural such items vertically aligned will be referred to as “displaying the items in a list.” Alternatively, vertically long items may be horizontally aligned, or three-dimensional items may be three-dimensionally arranged if the items are regularly aligned in a specific direction. Further, the display controller 100 controls the display of the file information 111 upon input of a later-described operation signal.

While the display controller 100 displays the file information 111 in a list, the operation detector 101 detects operation contents performed on the operation unit 13 by an operator. The operation detector 101 detects, as the operation contents, an operation such as an operation of touching the operation unit 13 with, for example, the tip of a finger of the operator (touching operation), an operation of touching and releasing the operation unit 13 (tapping operation), an operation of tracing on the operation unit 13 (dragging operation), or an operation of flicking on the operation unit 13 (flicking operation), or a combination of these operations.

The operation content determining unit 102 determines whether or not a specific operation has been performed on the basis of the above-described operation contents. The specific operation is determined by the operation position and the operation direction, for example.

The operation signal generating unit 103 generates the operation signal on the basis of the determination result of the operation content determining unit 102 to perform selection, selection cancellation, deletion, or execution of the file information 111. The operation signal is transmitted to the display controller 100 to display the status of the file information 111, such as selected, selection-cancelled, deleted, or executed.

The memory 11 stores the information processing program 110, the file information 111, and so forth for causing the controller 10 to operate as the above-described units 100 to 103.

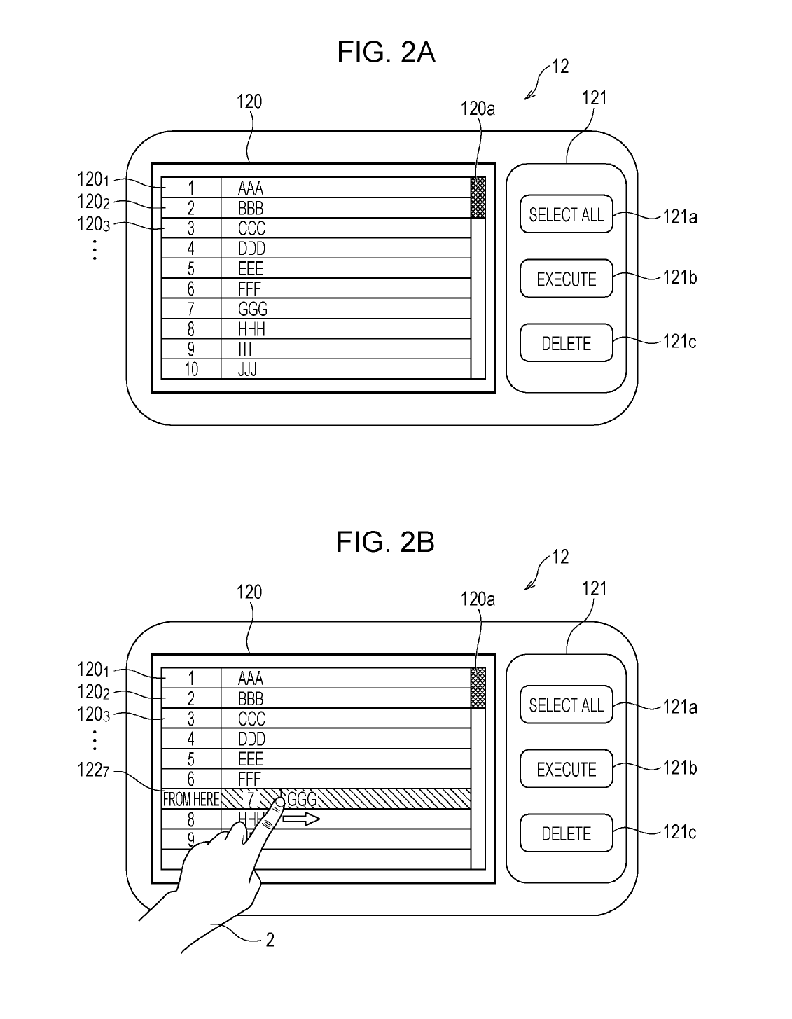

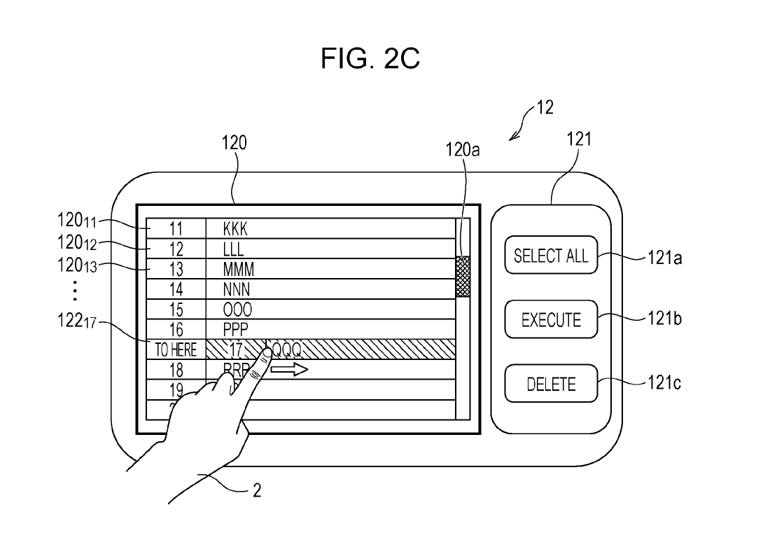

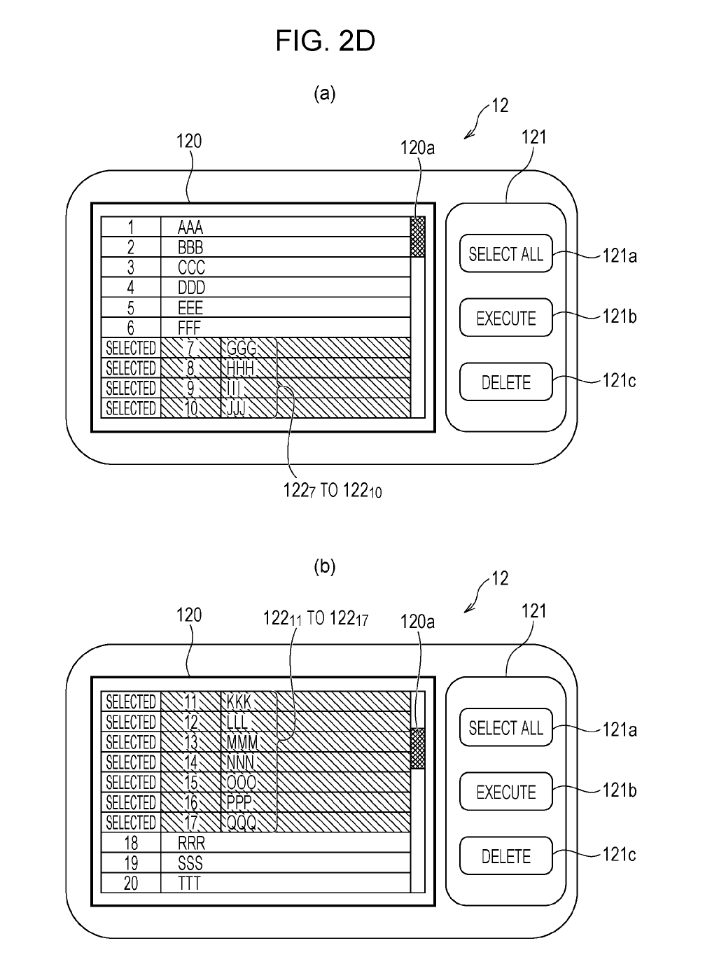

FIG. 2A is a schematic view illustrating an example of the configuration of a display screen when the file information 111 is displayed on the display 12 by the display controller 100.

The display 12 includes a display area 120 being an area for displaying the file information 111 and an operation area 121 including plural buttons 121a to 121c for generating the operation signal.

The display area 120 displays plural items 120₁, 120₂, 120₃, and so forth respectively corresponding to the file information 111 and vertically aligned. The display area 120 includes a scroll bar 120a for scrolling pages when the items 120₁, 120₂, 120₃, and so forth extend to plural pages and thus fail to fit in one screen.

The operation area 121 includes a select all button 121a, an execute button 121b, and a delete button 121c. The select all button 121a is for generating an operation signal for selecting all of the items 120₁, 120₂, 120₃, and so forth. The execute button 121b is for generating an operation signal for executing a piece of the file information 111 corresponding to a selected item. The delete button 121c is for generating an operation signal for deleting a piece of the file information 111 corresponding to a selected item.

### Operation of Information Processor

The operation of the present exemplary embodiment will now be described as divided into (1) an item selecting operation, (2) a selected item editing operation, and (3) a selection cancelling operation.

### (1) Item Selecting Operation

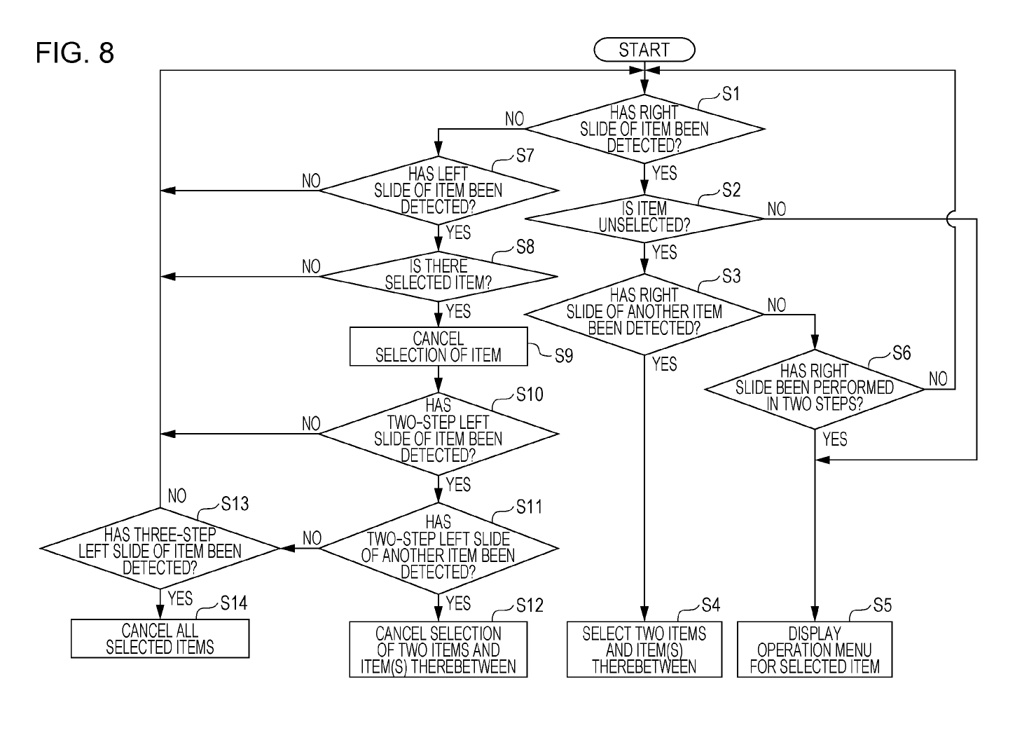

FIGS. 2B, 2C and parts (a) and (b) of FIG. 2D are schematic views for illustrating the item selecting operation of the information processors 1. FIG. 8 is a flowchart illustrating an operation example of the information processor 1.

As illustrated in FIG. 2B, when an operator 2 operates the operation unit 13 of the information processor 1 with the tip of a finger as the item selecting operation, the operator 2 first performs a dragging operation of dragging an item 122₇ rightward at a position corresponding to the item 122₇ in the display area 120 of the display 12 (hereinafter the dragging operation performed on an item will be referred to as “slide”).

Then, as illustrated in FIG. 2C, the operator 2 operates the scroll bar 120a to display items on the lower side of the page of the display area 120 (hereinafter referred to as “scroll”), and reaches a position at which an item 122₁₇ is displayed. Then, the operator 2 slides the item 122₁₇ rightward at a position corresponding to the item 122₁₇.

If the operation detector 101 and the operation content determining unit 102 of the information processor 1 detect the right slide performed on the above-described item 122₇ as a first operation (YES at step S1), and then if the item 122₇ is unselected (YES at step S2) and the right slide performed on the above-described item 122₁₇ is detected (YES at step S3), the operation signal generating unit 103 generates an operation signal for bringing the items 122₇ and 122₁₇ and the items located therebetween, i.e., the items 122₇ to 122₁₇ into a selected state. Then, the display controller 100 brings the items 122₇ to 122₁₇ into the selected state in the display area 120 in accordance with the operation signal, as illustrated in parts (a) and (b) of FIG. 2D (step S4).

The right slide described above as the first operation is an example. Thus, the first operation may be a slide performed in any direction different from the direction of scrolling the plural items. Further, the first operation may be any operation distinguishable from other operations, such as a touching operation other than the slide, plural touching operations, or a slide on plural contact points. In the case of the slide operation on plural contact points, the slide operation may be performed in the same direction as the scrolling direction.

### (2-1) Selected Item Editing Operation

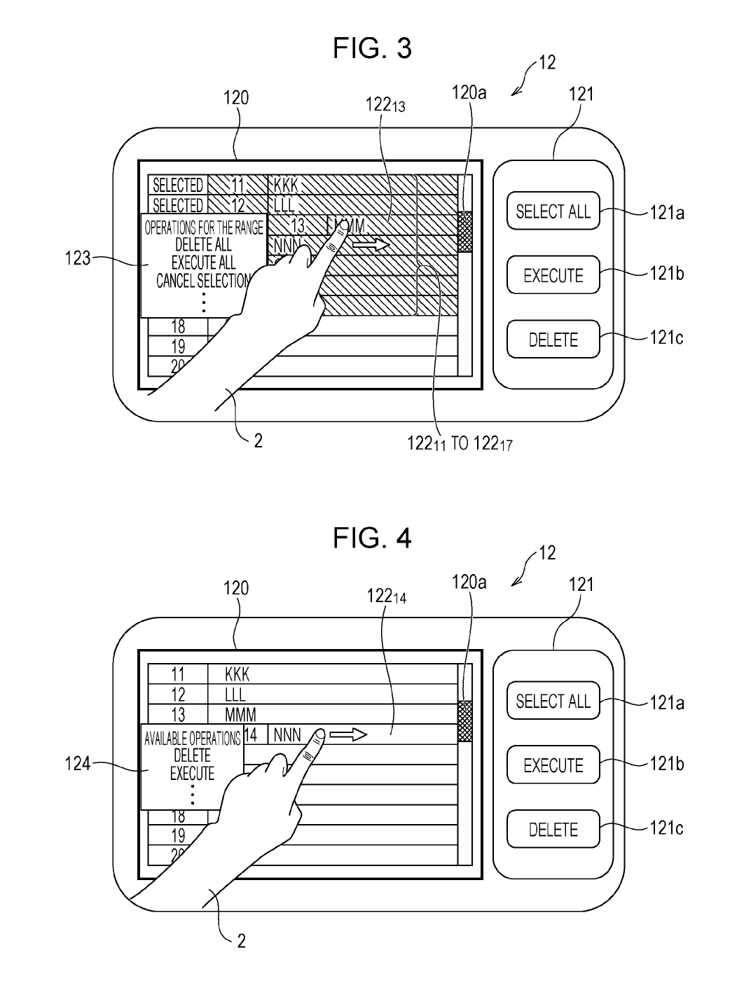

FIG. 3 is a schematic view for illustrating the selected item editing operation of the information processor 1.

As illustrated in FIG. 3, when the operator 2 operates the operation unit 13 of the information processor 1 with the tip of a finger, the operator 2 first performs the slide operation rightward at a position corresponding to an item 122₁₃ of the selected items 122₁₁ to 122₁₇ in the display area 120 of the display 12.

If the operation detector 101 and the operation content determining unit 102 of the information processor 1 detect the right slide performed on the above-described item 122₁₃ (YES at step S1), and if the items 122₁₁ to 122₁₇ are selected (NO at step S2), the operation signal generating unit 103 generates an operation signal for displaying an operation menu for the selected items, and the display controller 100 displays an operation menu 123 on the display 12 (step S5).

The operation menu 123 includes operation items such as “DELETE ALL,” “EXECUTE ALL,” and “CANCEL SELECTION” as operations for the selected items 122₁₁ to 122₁₇. If one of the operation items is touched, the operation signal generating unit 103 executes a corresponding operation.

### (2-2) Selected Item Editing Operation

FIG. 4 is a schematic view for illustrating another example of the selected item editing operation of the information processor 1.

As illustrated in FIG. 4, when the operator 2 operates the operation unit 13 of the information processor 1 with the tip of a finger, the operator 2 first performs the slide operation rightward at a position corresponding to an unselected item 122₁₄ in the display area 120 of the display 12.

If the operation detector 101 and the operation content determining unit 102 of the information processor 1 detect the right slide performed on the above-described item 122₁₄ (YES at step S1) and there is no selected item (YES at step S2), and if the right slide performed on another item is not detected unlike “(1) the item selecting operation” (NO at step S3) and the right slide has been performed in two steps (YES at step S6), the operation signal generating unit 103 generates an operation signal for displaying an operation menu for the item 122₁₄. Then, the display controller 100 displays an operation menu 124 on the display 12 (step S5). Herein, a slide having a slide distance not exceeding a given threshold may be referred to as a “one-step” slide, and a slide having a slide distance exceeding the threshold may be referred to as a “two-step” slide. Alternatively, a single slide may be referred to as a “one-step” slide, and a double slide may be referred to as a “two-step” slide.

The operation menu 124 includes operation items such as “DELETE” and “EXECUTE” as operations for the selected item 122₁₄. If one of the operation items is touched, the operation signal generating unit 103 executes a corresponding operation.

Further, if the right slide has been performed in one step at step S6 (NO at step S6), only the item 122₁₄ is brought into the selected state similarly to the example illustrated in FIG. 2B, and the information processor 1 stands by until the next operation starts.

### (3-1) Selection Canceling Operation

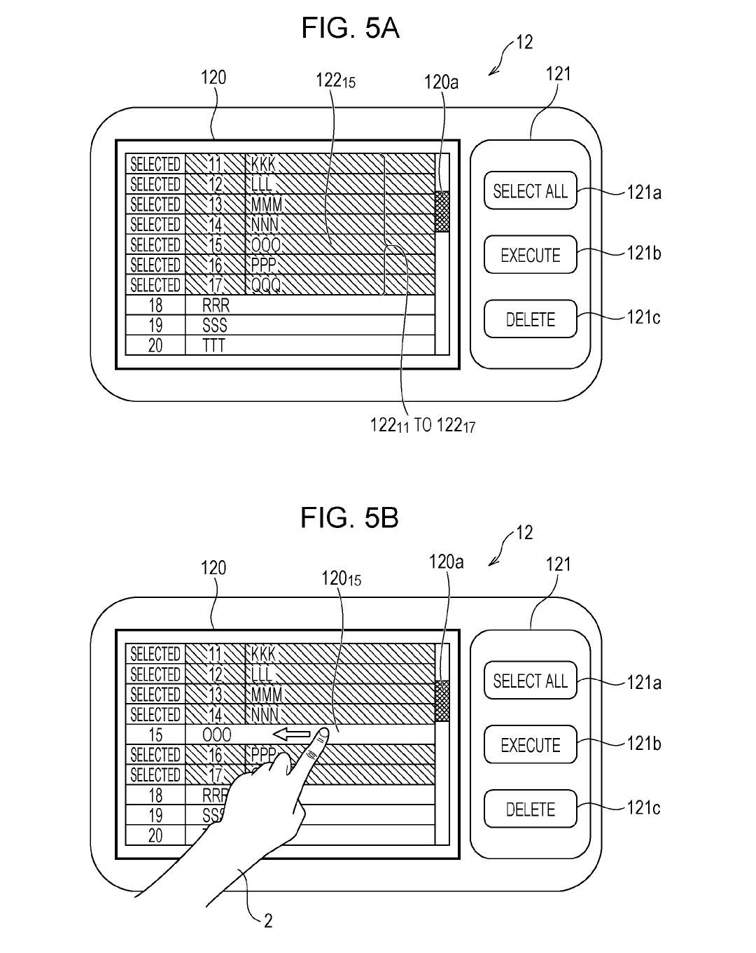

Description will now be given of an operation of cancelling the selection on the assumption that plural items are selected, as illustrated in FIG. 5A described below.

FIGS. 5A and 5B are schematic views for illustrating the selection cancelling operation of the information processor 1.

As illustrated in FIGS. 5A and 5B, when the operator 2 operates the operation unit 13 of the information processor 1 with the tip of a finger, the operator 2 first performs the slide operation leftward at a position corresponding to an item 122₁₅ of the selected items 122₁₁ to 122₁₇ in the display area 120 of the display 12.

If the operation detector 101 and the operation content determining unit 102 of the information processor 1 detect the left slide performed on the above-described item 122₁₅ as a second operation (NO at step S1 and YES at step S7), and if there is a selected item (YES at step S8), the operation signal generating unit 103 generates an operation signal for cancelling the selection of the item. Then, the display controller 100 cancels the selection of the item 122₁₅ to obtain the item 120₁₅, as illustrated in FIG. 5B (step S9).

The left slide described above as the second operation is an example. Thus, the second operation may be any other operation different from the first operation.

### (3-2) Selection Cancelling Operation

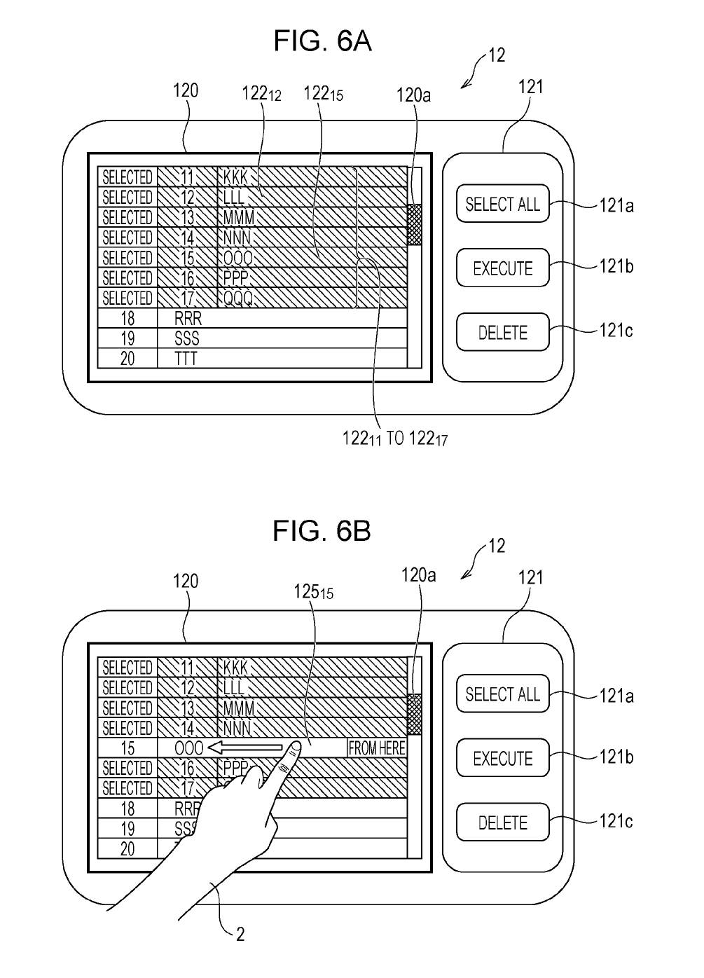

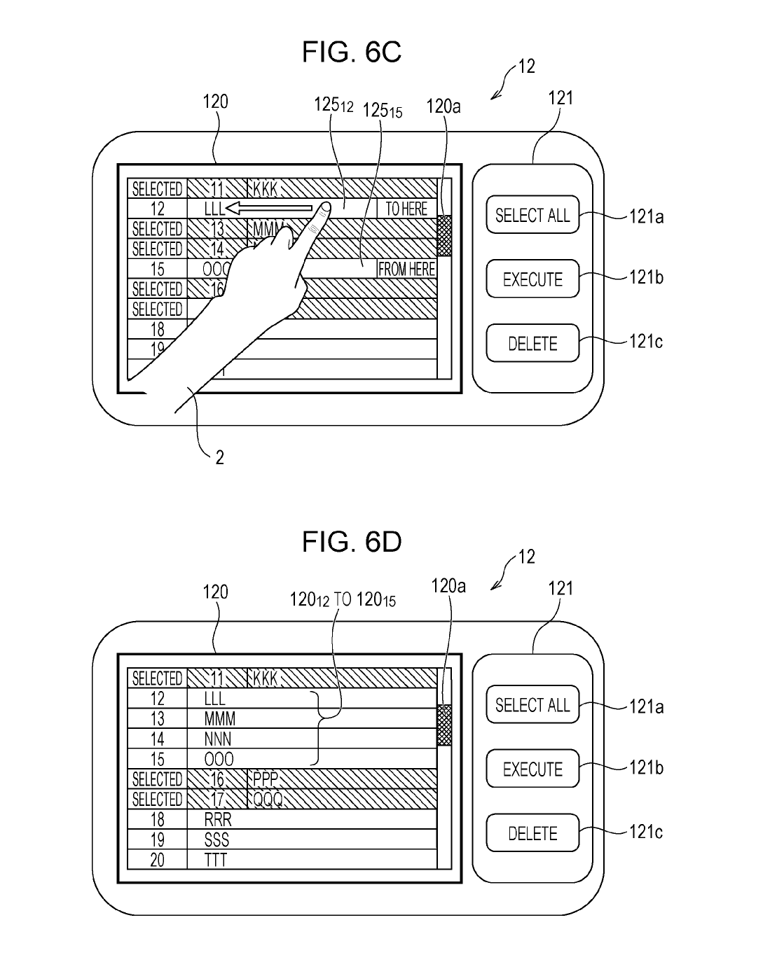

FIGS. 6A to 6D are schematic views for illustrating another example of the selection cancelling operation of the information processor 1.

As illustrated in FIGS. 6A and 6B, when the operator 2 operates the operation unit 13 of the information processor 1 with the tip of a finger, the operator 2 first performs the slide operation leftward in two steps at the position corresponding to the item 122₁₅ of the selected items 122₁₁ to 122₁₇ in the display area 120 of the display 12.

Then, as illustrated in FIGS. 6A and 6C, the operator 2 performs the slide operation leftward in two steps at a position corresponding to an item 122₁₂ of the items 122₁₁ to 122₁₇.

If the operation detector 101 and the operation content determining unit 102 of the information processor 1 detect the two-step left slide performed on the above-described item 122₁₅ (YES at step S10), the operation signal generating unit 103 generates an operation signal for setting the item 122₁₅ as a selection cancellation start item. Then, the display controller 100 cancels the item 122₁₅ to obtain a selection cancellation start item 125₁₅, as illustrated in FIG. 6B. Further, if the two-step left slide performed on the item 122₁₂ other than the item 122₁₅ is detected (YES at step S11), the operation signal generating unit 103 generates an operation signal for setting the item 122₁₂ as a selection cancellation end item. Then, the display controller 100 sets the item 122₁₂ as a selection cancellation end item 125₁₂, as illustrated in FIG. 6C. As a result, the operation signal generating unit 103 generates an operation signal for cancelling the selection of the two items 122₁₂ and 122₁₅ and the items located therebetween, and the display controller 100 cancels the selection of the items 122₁₂ to 122₁₅ to obtain the items 120₁₂ to 120₁₅, as illustrated in FIG. 6D (step S12).

### (3-3) Selection Cancelling Operation

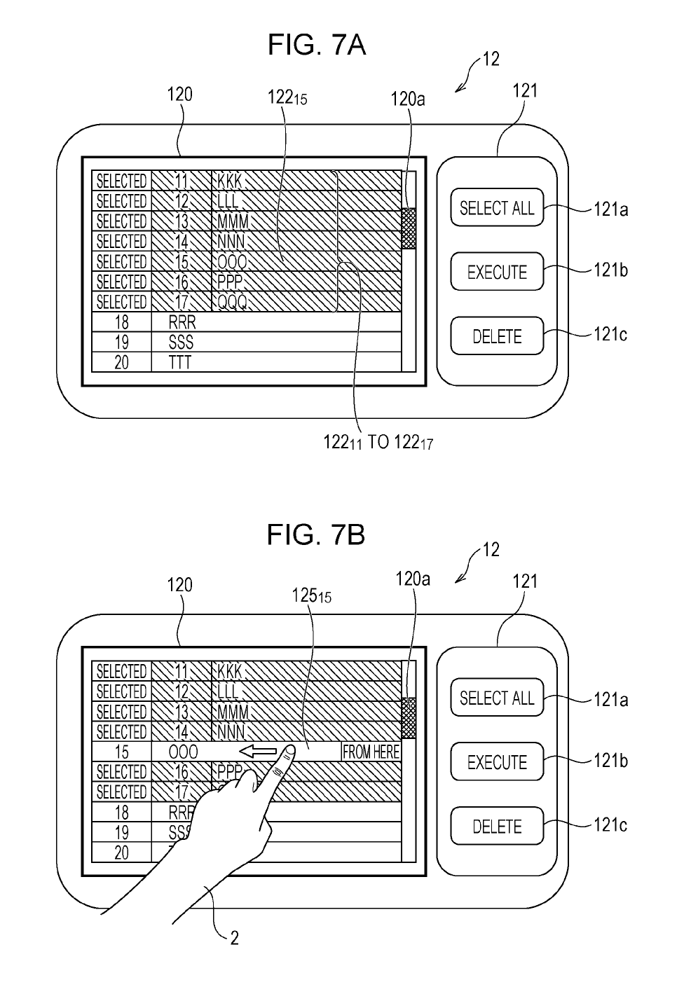

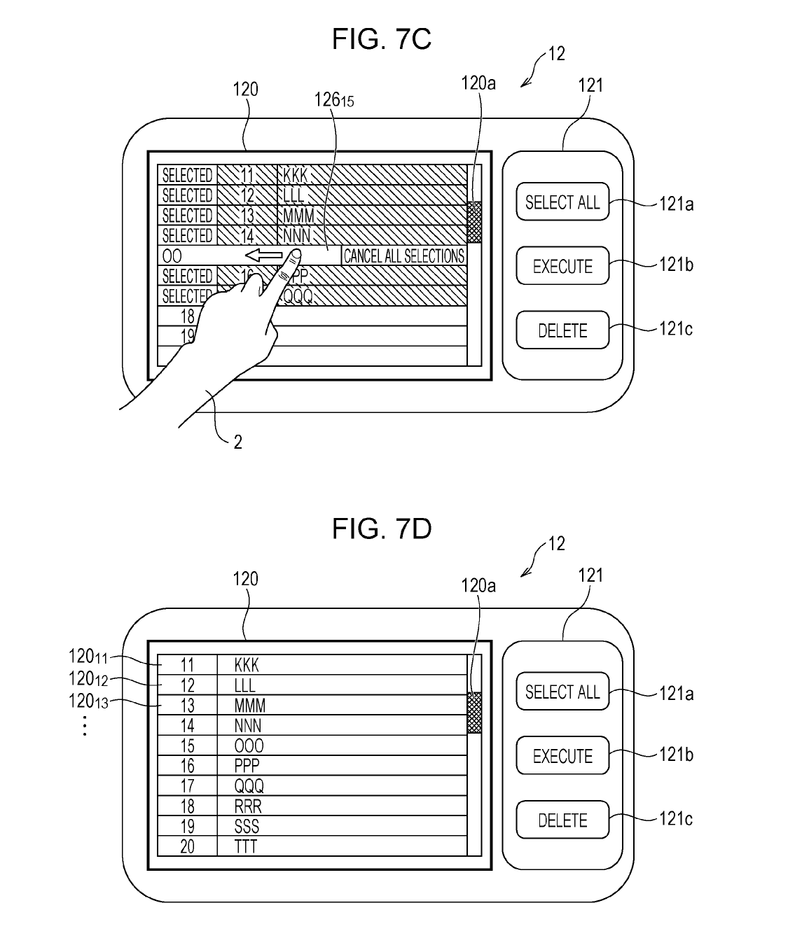

FIGS. 7A to 7D are schematic views for illustrating another example of the selection cancelling operation of the information processor 1.

As illustrated in FIGS. 7A and 7B, when the operator 2 operates the operation unit 13 of the information processor 1 with the tip of a finger, the operator 2 first performs the slide operation leftward in two steps at the position corresponding to the item 122₁₅ of the selected items 122₁₁ to 122₁₇ in the display area 120 of the display 12.

Then, as illustrated in FIGS. 7B and 7C, the operator 2 further performs the slide operation (third step) leftward at a position corresponding to the item 125₁₅.

If the operation detector 101 and the operation content determining unit 102 of the information processor 1 detect the two-step left slide performed on the above-described item 122₁₅ (YES at step S10), the operation signal generating unit 103 generates the operation signal for setting the item 122₁₅ as the selection cancellation start item, and the display controller 100 cancels the item 122₁₅ to obtain the selection cancellation start item 125₁₅, as illustrated in FIG. 7B. Then, if the two-step left slide performed on an item other than the item 122₁₅ is not detected (NO at step S11), and if the three-step left slide performed on the selection cancellation start item 125₁₅ is detected (YES at step S13), the operation signal generating unit 103 generates an operation signal for setting the selection cancellation start item 125₁₅ as an all selections cancellation item 126₁₅. Then, the display controller 100 sets the selection cancellation start item 125₁₅ as the all selections cancellation item 126₁₅. Thereafter, the operation signal generating unit 103 generates an operation signal for cancelling the selection of all of the selected items 122₁₁ to 122₁₇, and the display controller 100 cancels the selection of the items 122₁₁ to 122₁₇ to obtain the items 120₁₁ to 120₁₇, as illustrated in FIG. 7D (step S14).

### Other Exemplary Embodiments

The present invention is not limited to the above-described exemplary embodiment, and may be modified in various ways within the scope not departing from the gist of the invention.

In the above-described exemplary embodiment, the functions of the units 100 to 103 of the controller 10 are realized by a program. However, the units may be entirely or partially realized by hardware, such as an application specific integrated circuit (ASIC). Further, the program employed in the above-described exemplary embodiment may be provided as stored in a recording medium, such as a compact disc read only memory (CD-ROM). Further, the steps described in the above-described exemplary embodiment may be reordered, deleted, or added with other steps, for example, within the scope not changing the gist of the invention.

What is claimed is:

1. An information processor comprising:
a display controller that controls display of a plurality of items displayed in alignment on a display on the basis of operation contents performed on an operation unit disposed to be superimposed on the display,
wherein if a first operation involving contact with the operation unit is performed on one item and another item of the plurality of items, the display controller controls the display to bring a plurality of aligned items from the one item to the another item into a selected state.

2. The information processor according to claim 1, further comprising:
an operation signal generating unit that, if the first operation is performed on one item of the plurality of items in the selected state, generates an operation signal for causing the display controller to display operation items for the plurality of items in the selected state.

3. The information processor according to claim 1, further comprising:
an operation signal generating unit that, if a second operation different from the first operation and involving contact with the operation unit is performed on one item of the plurality of items in the selected state, generates an operation signal for causing the display controller to cancel the selected state of the one item.

4. The information processor according to claim 1, further comprising:
an operation signal generating unit that, if a second operation different from the first operation and involving contact with the operation unit is performed in two steps on one item and another item of the plurality of items in the selected state, generates an operation signal for causing the display controller to cancel the selected state of a plurality of items from the one item to the another item.

5. The information processor according to claim 1, further comprising:
an operation signal generating unit that, if a second operation different from the first operation and involving contact with the operation unit is performed in three steps on one item of the plurality of items in the selected state, generates an operation signal for causing the display controller to cancel the selected state of the plurality of items in the selected state.

6. A non-transitory computer readable medium storing a program causing a computer, which includes a display and an operation unit disposed to be superimposed on the display, to execute a process for information processing, the process comprising:
displaying a plurality of items in alignment on the display, and controlling the display of the plurality of items on the basis of operation contents performed on the operation unit,
wherein if a first operation involving contact with the operation unit is performed on one item and another item of the plurality of items, the displaying controls the display to bring a plurality of aligned items from the one item to the another item into a selected state.

7. An information processing method comprising:
controlling display of a plurality of items displayed in alignment on a display on the basis of operation contents performed on an operation unit disposed to be superimposed on the display,
wherein if a first operation involving contact with the operation unit is performed on one item and another item of the plurality of items, the controlling controls the display to bring a plurality of aligned items from the one item to the another item into a selected state.
